(19) United States
(12) Patent Application Publication
(10) Pub. No.: US 2026/0268368 A1
(43) Pub. Date: Sep. 10, 2026

(54) DIGITAL INCREMENTAL CONVERSION

(71) Applicant: VIDEOAMP, INC., Los Angeles, CA (US)

(72) Inventors: Gregory Michael Faletto, Los Angeles, CA (US); Keith David Landry, Culver City, CA (US); Kathryn Elaine Mitchell, Austin, TX (US); Abtin Shahidi, Los Angeles, CA (US); James Robert Koehler, Boulder, CO (US)

(73) Assignee: VIDEOAMP, INC., Los Angeles, CA (US)

(21) Appl. No.: 19/561,389

(22) Filed: Mar. 9, 2026

Related U.S. Application Data
(60) Provisional application No. 63/768,819, filed on Mar. 7, 2025.

(51) Int. Cl. G06Q 30/0242

(52) U.S. Cl. CPC G06Q 30/0242

(57) ABSTRACT

A method may include obtaining observational data associated with a digital advertising campaign for multiple households. The method may also include estimating a likelihood that a household of the multiple households may be reached by the digital advertising campaign and a counterfactual conversion outcome for a reached household. The estimating may be performed as a function of the one or more covariates. The method may further include generating an estimate of incremental conversions attributable to the digital advertising campaign by combining differences between the observed conversion outcome of the reached households and the counterfactual conversion outcome for the reached households and a propensity-based correction derived from outcomes of the plurality of households based on the estimated likelihood that a household is reached. The method may also include outputting the estimate of incremental conversions.

### CROSS REFERENCE TO RELATED APPLICATIONS

This U.S. patent application claims priority to U.S. Provisional Patent Application No. 63/768,819, titled “DIGITAL INCREMENTAL CONVERSION,” and filed on Mar. 7, 2025, the disclosure of which is hereby incorporated by reference in its entirety.

### TECHNICAL FIELD

This disclosure relates to incremental conversion, and more specifically, to digital incremental conversion with respect to advertisements.

### BACKGROUND

Unless otherwise indicated herein, the materials described herein are not prior art to the claims in the present application and are not admitted to be prior art by inclusion in this section.

Determining an effectiveness of an advertising campaign may include determining a number of conversions that occur due to the advertising campaign and/or viewership thereof. In some instances, it may be possible to determine a total number of conversions which may or may not be associated with viewing of an advertisement of the advertising campaign. In some instances, it may be difficult to determine a number of conversions that happened due to the advertising campaign versus a number of conversions that happened without regard to the advertising campaign.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining observational data associated with a digital advertising campaign for multiple households. The observational data may include a reach indicator, one or more covariates, and an observed conversion outcome. The method may also include estimating a likelihood that a household of the multiple households may be reached by the digital advertising campaign and a counterfactual conversion outcome for a reached household. The estimating may be performed as a function of the one or more covariates. The counterfactual conversion outcome may be estimated using data from unreached households of the multiple households. The method may further include generating an estimate of incremental conversions attributable to the digital advertising campaign by combining differences between the observed conversion outcome of the reached households and the counterfactual conversion outcome for the reached households, and a propensity-based correction derived from outcomes of the plurality of households based on the estimated likelihood that a household may be reached. The method may also include outputting the estimate of incremental conversions.

In another example embodiment, a system may include one or more non-transitory computer-readable storage media configured to store instructions. The system may also include one or more processors communicatively coupled to the one or more non-transitory computer-readable storage media and configured to, in response to execution of the instructions, cause the system to perform operations. The operations may include obtain observational data associated with a digital advertising campaign for multiple households. The observational data may include a reach indicator, one or more covariates, and an observed conversion outcome. The operations may also include estimate a likelihood that a household of the multiple households may be reached by the digital advertising campaign and a counterfactual conversion outcome for a reached household. The estimate may be performed as a function of the one or more covariates. The counterfactual conversion outcome may be estimated using data from unreached households of the multiple households. The operations may further include generate an estimate of incremental conversions attributable to the digital advertising campaign by combining differences between the observed conversion outcome of the reached households and the counterfactual conversion outcome for the reached households, and a propensity-based correction derived from outcomes of the multiple households based on the estimated likelihood that a household is reached. The operations may also include output the estimate of incremental conversions.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for digital incremental conversion;

FIG. 2 illustrates an example propensity model for incremental conversion;

FIG. 3 illustrates an example outcome model for incremental conversion;

FIG. 4 illustrates a flowchart of an example method of digital incremental conversion; and

FIG. 5 illustrates an example computing device.

### DETAILED DESCRIPTION

Measuring whether a digital advertising campaign causes a conversion may be a difficult task as determining what might have happened in the absence of viewing an advertisement may be difficult. Households who may be reached by ads may differ from other households not reached by the ads (e.g., watching more of a particular platform or satisfying particular targeting rules). As such, comparing conversion rates between reached households and unreached households may yield misleading results. As a result, advertising entities may over-credit the digital advertising campaign for conversions that would have occurred without the ads, or under-credit the digital advertising campaign when the unreached households may not be comparable. The problem may lie in estimating the digital advertising campaign's true incremental impact, or the conversions that occurred because of the ads, using real-world data where exposure may not be randomly assigned.

Some prior approaches may implement comparisons, matching, and/or single-model adjustments to estimate what conversions may have happened without ads. Alternatively, or additionally, A/B tests or holdout tests may be used, but may be costly, slow, and/or difficult to run at scale. Alternatively, or additionally, the observational methods may be insufficient as the reached households and the unreached household likely include differences, such that models may misrepresent either of the households. In some instances, matching may break down in view of many variables and/or poor fittings between the variables. Single models may include biases instances in which a reach model or an outcome model may be incorrect which may lead to misleading lift estimates.

Aspects of the present disclosure address these and other limitations by building complementary predictions from real campaign data, where one prediction may estimate how likely each household was to be reached (e.g., to account for targeting and selection effects), and the other prediction may estimate what reached households may have done without ads by learning patterns from similar unreached households. The present disclosure may combine the two predictions so that in instances in which the first prediction is imperfect, the second prediction may help correct it, producing a more reliable estimate of true incremental conversions (e.g., lift) relative to comparisons, matching, and/or single-model adjustments. The predictions and estimations of incremental conversions may be run at scale on observational data and can also support segment-level reporting and/or uncertainty estimates.

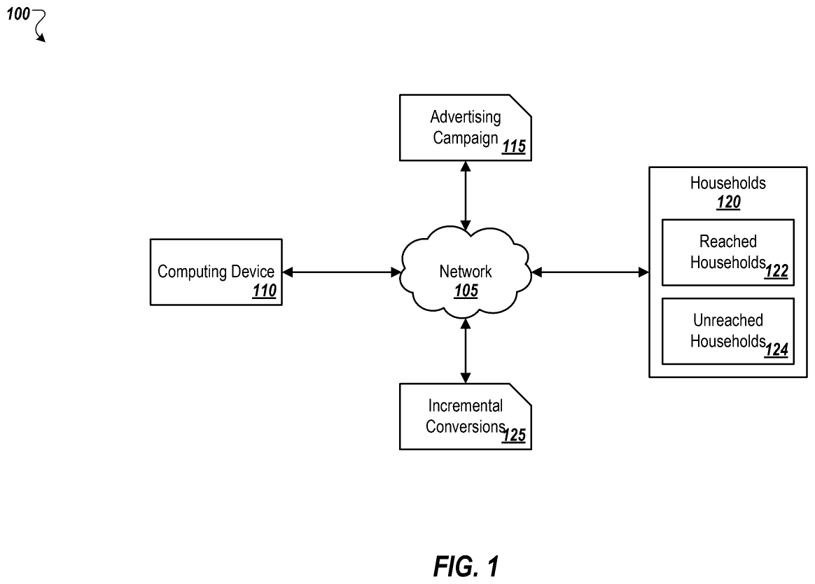

FIG. 1 illustrates a block diagram of an example system 100 for digital incremental conversion. The system 100 may include a network 105, a computing device 110, and households 120. The households 120 may include reached households 122 and unreached households 124.

The network 105 may be operable to facilitate communications between one or more systems and/or devices that may be communicatively coupled to the network 105. For example, as illustrated in FIG. 1, the computing device 110 may be operable to communicate with the households 120 via the network 105, such as to provide an advertising campaign 115 and/or obtain incremental conversions 125. The network 105 may include wireless network links, wired network links, and/or a combination of wireless and wired network links. For example, the network 105 may include various wired technologies, such as Ethernet, fiber optics, coaxial, etc., and/or the network 105 may include various wireless technologies, such as Bluetooth, Wi-Fi, satellite, infrared, etc., and/or combinations thereof.

The computing device 110 may be operable to perform operations associated with digital incremental conversion, as described herein. The computing device 110 may be operable to communicate with one or more other systems and/or devices, such as via the network 105. For example, the computing device 110 may utilize the network 105 to obtain data associated with the advertising campaign 115, the households 120, and/or the incremental conversions 125. For example, the computing device 110 may cause the advertising campaign 115 to be delivered to the households 120 (and/or a subset of the households 120, such as the reached households 122) and the computing device 110 may obtain the incremental conversions 125 that may be associated with the advertising campaign 115, subject to the operations described herein.

Advertising entities using the advertising campaign 115 may want to determine an effectiveness of the advertising campaign 115 on consumers, such as by way of the households 120. In some instances, the effectiveness of the advertising campaign 115 may be determined based on the incremental conversions 125 that may occur due to the advertising campaign 115. A conversion may occur when a product associated with the advertising campaign 115 may be purchased by a consumer, which may include purchases not affected by a view of the advertising campaign 115.

In an example, a first company may prepare and/or run an advertising campaign 115 that may expose the households 120 (e.g., at least one person within the household) to the advertisement (e.g., the reached households 122), while some comparable households may not be exposed (e.g., the unreached households 124). The households 120 may be considered comparable based on one or more similar factors between the households 120, as described herein.

A first household may be in a first geographic location and a second household may be in a second geographic location. A first incident may affect the first geographic location and/or the movement of people within the first geographic location (e.g., a rain storm may cause a household to decide to stay home instead of go out to a movie), while the second household may opt to go out to a movie. The first household may observe an advertisement associated with a consumer product (as the first household remained home) and the second household may not observe the advertisement (as the second household was not home). On the following day, the first household went out to purchase the consumer product and the advertising entity would like to know whether the conversion was caused by the viewing of the advertisement, or if the conversion would have happened without regard to the viewing of the advertisement.

In the example, if the second household was comparable to the first household and the second household also purchased the consumer product, the advertisement may have been less likely to have caused the conversion. Alternatively, if the second household failed to purchase the consumer product, then the advertisement may have at least contributed to causing the first household to purchase the consumer product.

In many situations, the advertising entity may be operable to determine a total number of conversions that take place for a given product, and it may be desirable to the advertising entity to determine and/or approximate the number of conversions that may occur that may be attributable to an advertising campaign. In some instances, the advertising entity may attempt to determine a number of conversions that may happen regardless of an advertisement to compare to the total number of conversions, which may determine the incremental conversions 125 (or incremental lift), which may reflect a number of conversions that may be due to the advertisement.

Some prior attempts to determine the incremental conversions 125 may utilize randomized experiments which may be impractical and/or expensive. Some prior attempts may attempt to compare reached and unreached households, which may introduce a selection bias. For example, some of the reached households 122 may have a different distribution of confounding variables than the unreached households 124. For example, some people that watch a cooking show may be more likely to be reached by advertisements for cookware and/or may have a higher spend on cookware regardless of whether a cooking advertisement was viewed. In such circumstances, fewer of the unreached households 124 may be determined to watch cooking shows relative to the reached households 122, and therefore, average conversions of the unreached households 124 may not accurately reflect what may have happened to reached households 122 if the reached households 122 had not seen the advertising campaign 115. In some instances, matching may be used as an attempt to control some confounding variables (e.g., viewership).

In some instances, some relevant confounding variables may be measured and/or controlled such that outcomes from the reached households 122 and the unreached households 124 may be used to estimate incremental conversion using matching. In some instances, matching on many confounders may not be practical as some of the households 120 may not have matches to other households, which may result in wasted data. In some instances, many matches may be discovered when some confounders may not be controlled, which may result in the incremental conversions 125 being invalid. For a more robust and/or a more accurate incremental conversion estimate, a double robust approach may be utilized, as described herein.

In some instances, a double/debiased machine learning (DML) estimator may be used to estimate the incremental conversions 125. In some instances, the DML estimator may use a propensity model and/or an outcome model. The propensity model may be operable to estimate counterfactual conversions by comparing the outcomes of the reached households 122 and the unreached households 124 with similar demographics (e.g., similar to matching). The outcome model may be trained on the unreached households 124 to estimate what may have happened to the reached households 122 with similar confounders had the reached households 122 not been reached by the advertising campaign 115. The DML estimator may then combine the models (e.g., the propensity model and the outcome model) to estimate the incremental conversions 125. In these and other instances, the DML estimator may be performed by, or operate within, the computing device 110.

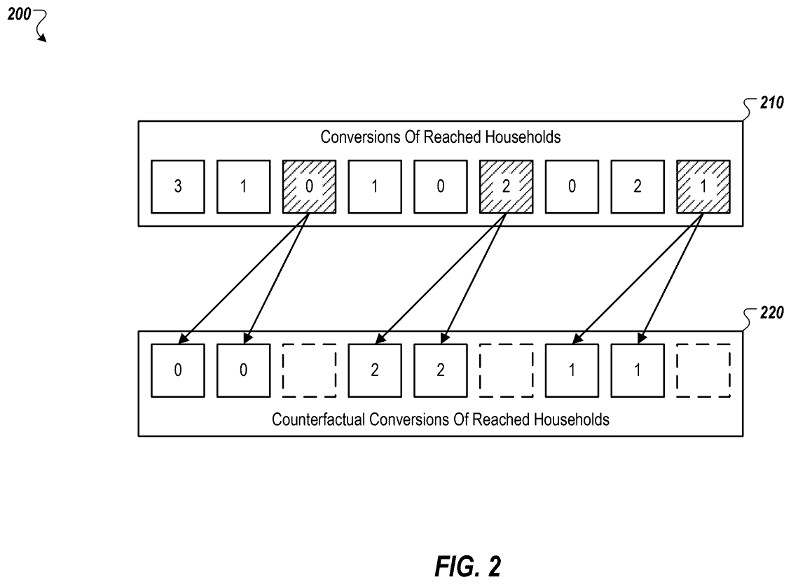

FIG. 2 illustrates an example propensity model for incremental conversion. The propensity model 200 may be operable to estimate a ratio of the reached households 122 to the unreached households 124, in each bucket, to determine how much weight may be applied to each of the unreached households 124. In the example propensity model 200, all of the households in a bucket may include the same number of confounders.

The propensity model 200 may identify a bucket of households (e.g., conversions of reached households 210) and determine that for a number of reached households, there may be a number of unreached households in the bucket. For example, as illustrated, for every two reached households, there may be one unreached household (shaded portions of the conversion of reached households 210). The conversions from the unreached households in the first bucket may be applied in a similar ratio to the households from the second bucket, or the counterfactual conversions of reached households 220 (e.g., a hypothetical for the reached households where no advertisements may have been viewed). As illustrated, seven conversions may have occurred relative to the reached households (e.g., a sum of the non-shaded conversions of reached households 210) and six conversions may be estimated for the reached households (e.g., a sum of the non-dashed counterfactual conversions of reached households 220), such that the propensity model 200 may estimate one total incremental conversion (e.g., seven conversions of reached households 210 minus six counterfactual conversions of reached households 220).

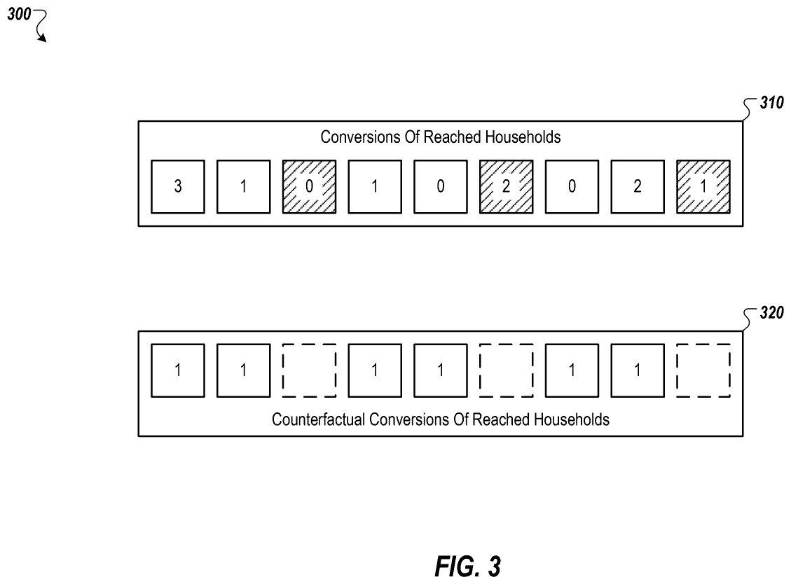

FIG. 3 illustrates an example outcome model 300 for incremental conversion. The outcome model 300 may be trained on unreached households in order to estimate what may have happened to conversions associated with a reached household.

Similar to the propensity model 200 of FIG. 2, the conversions of reached households 310 may be arranged such that there may be two reached households for every one unreached household (e.g., the shaded households in the conversions of reached households 310). The outcome model 300 may be trained on the unreached households and may determine an average number of conversions per unreached households (e.g., as illustrated in FIG. 3, there may be 0+2+1=3 conversions from the three unreached households, such that there may be one conversion per unreached household). The count of the conversions of reached household 310 may be seven for the example provided. In the counterfactual conversions of reached households 320, the estimate for each reached household may be one (e.g., based on the above calculation) to determine an estimate of the number of conversions for reached households had the reached households not seen the advertisement. As illustrated, the number of the conversions of reached households 310 may be seven and the number of counterfactual conversions of reached households may be six, such that the outcome model may estimate one total incremental conversion (e.g., seven reached household conversions minus six estimated reached household conversions).

The DML estimator within the computing device 110 may be operable to combine the propensity model 200 and the outcome model 300 approaches to estimate the incremental conversions 125 with a consensus between the two models. In some instances, errors occurring in either of the models may be corrected by the inclusions of the other model, such that the estimate for the incremental conversions 125 may be improved. In some instances, the propensity model 200 and the outcome model 300 may be trained on an entire data set and/or may be configured to pool information across similar demographic buckets, such that more information may be extracted therefrom relative to matching.

Provided herein are some mathematical equations associated with the DML estimator, the propensity model, and/or the outcome model as described herein. One potential key to the assumptions may be some overlap, where for some η>0, η≤e(X)≤1−η for all Xi, and unconfoundedness Y(1), Y(0)⊥W|X. In some instances, the sample may be used to estimate the nuisance parameters as functions using Ŷ(0)(X)≈μ₀(X) and for brevity, the estimate for the household i may be written as Ŷ(0)(Xᵢ)=Ŷᵢ(0), and a propensity score function may be ê(X)≈e(X).

In some instances, a model for unreached potential outcomes may be used as the total number of conversions that the reached households would have had if they had not been reached is to be estimated. In some instances, N₁ may be the number of exposed households in the universe, where n₁=ΣWᵢ may be the number of sampled households that may receive treatment. In some instances, the DML estimator may be given by:

$$0 = \frac{1}{n} {\sum }_{i = 1}^{\text{?}} ( {W}_{i} \frac{{Y}_{i} - {{Y}^{\text{?}}}_{i} ( 0 )}{ℙ ( W = 1 )} - ( 1 - {W}_{i} ) \frac{{e}^{\text{?}} ( {X}_{i} )}{1 - {e}^{\text{?}} ( {X}_{i} )} \frac{{Y}_{i} - {{Y}^{\text{?}}}_{i} ( 0 )}{ℙ ( W = 1 )} - {W}_{i} \frac{{{τ}^{\text{?}}}_{ATT}}{ℙ ( W = 1 )} )$$

$$\begin{matrix}{{τ}^{\text{?}}}_{ATT} {\sum }_{i = 1}^{n} {W}_{i} = {\sum }_{i = 1}^{n} ( {W}_{i} ( {Y}_{i} - {{Y}^{\text{?}}}_{i} ( 0 ) ) - ( 1 - {W}_{i} ) \frac{{e}^{\text{?}} {X}_{i}}{1 - {e}^{\text{?}} {X}_{i}} ( {Y}_{i} - {{Y}^{\text{?}}}_{i} ( 0 ) ) ) \\ = {\sum }_{{W}_{\text{?}} = 1} ( {Y}_{i} - {{Y}^{\text{?}}}_{i} ( 0 ) ) - {\sum }_{{W}_{\text{?}} = 0} ( \frac{{e}^{\text{?}} {X}_{i}}{1 - {e}^{\text{?}} {X}_{i}} ( {Y}_{i} - {{Y}^{\text{?}}}_{i} ( 0 ) ) )\end{matrix}$$

$${{τ}^{\text{?}}}_{ATT} = {\underbrace{\frac{1}{{n}_{1}} {\sum }_{{W}_{\text{?}} = 1} ( {Y}_{i} - {{Y}^{\text{?}}}_{i} ( 0 ) )}}_{( \text{?} )} - {\underbrace{\frac{1}{{n}_{1}} {\sum }_{{W}_{\text{?}} = 1} ( \frac{{e}^{\text{?}} {X}_{i}}{1 - {e}^{\text{?}} {X}_{i}} ( {Y}_{i} - {{Y}^{\text{?}}}_{i} ( 0 ) ) )}}_{( \text{?} )}$$

$$\text{?} \text{indicates text missing or illegible when filed}$$

where it may be assumed that ê(·) and \hat{μ}₀(·)may have been estimated on a data set that may be independent of the (Wᵢ, Xᵢ, Yᵢ) that may be plugged in in the sum. In some instances, if the outcome model is consistent, then the first term may provide the treatment effect and the second term may be approximately mean-zero noise regardless of the propensity model. In some instances, a good estimate of μ₀(Xᵢ) may result in the above equations being a good estimate for the total incremental conversions.

In some instances, the first term in the above equation may approximate τ_{ATT}, and if the outcome model Ŷ(0)(X) is a good approximation of μ₀(X), which may be had for the true nuisance function:

$$𝔼 [ \frac{1}{n} * {\sum }_{{W}_{i} = 1} ( {Y}_{i} - {μ}_{0} ( {X}_{i} ) ) ] = {τ}_{A T T}$$

where the expectation may be taken over samples of size n.

In some instances, the outcome model is equal to μ₀(Xᵢ), which may be without regard to whether the propensity model may be incorrect. As such, for any arbitrary f(Xᵢ) that takes on values between η and 1−η for some η>0,

$$𝔼 [ {\sum }_{\{ i : {W}_{i} = 0 \}} \frac{f ( {X}_{i} )}{1 - f ( {X}_{i} )} ( {Y}_{i} - {μ}_{0} ( {X}_{i} ) ) ] = 0$$

In instances in which the propensity model is known, then the above term (noted with the (**) symbol), may correct for bias in μ₀(Xᵢ) for estimating the untreated potential outcomes of the treated units:

$$𝔼 [ \frac{1}{{n}_{1}} * {\sum }_{{W}_{i} = 0} \frac{e ( {X}_{i} )}{1 - e ( {X}_{i} )} ( {Y}_{i} - {\hat{Y}}_{i} ( 0 ) ) ] = 𝔼 [ {Y}_{i} ( 0 ) \vert {W}_{i} = 1 ] - 𝔼 [ {\hat{Y}}_{i} ( 0 ) \vert {W}_{i} = 1 ]$$

In some instances, the observed outcomes of the unreachable households may be used to evaluate the outcome model. In instances in which the outcome model is not good, the (**) term may correct for errors in the outcome model. As such, the estimate of incremental conversions may be accurate if either the outcome model or the propensity model may be correctly applied, which may provide a doubly robust property.

In some instances, an estimate for the total incremental conversions may be simplified by first observing:

$$\frac{{W}_{i} - {e}^{\text{?}} ( {X}_{i} )}{1 - {e}^{\text{?}} ( {X}_{i} )} = \{ \begin{matrix}1 , & {W}_{\text{?}} = 1 , \\ \frac{- {e}^{\text{?}} ( {X}_{\text{?}} )}{1 - {e}^{\text{?}} ( {X}_{\text{?}} )} & {W}_{i} = 0.\end{matrix}$$

$$\text{?} \text{indicates text missing or illegible when filed}$$

Using the nearest above formula, the DML estimator may be rewritten as:

$${{τ}^{\text{?}}}_{ATT} = \frac{1}{{N}_{1}} {\sum }_{i = 1}^{\text{?}} {{Z}^{\text{?}}}_{i}$$

$$where$$

$${{Z}^{\text{?}}}_{i} := \frac{{W}_{i} - {e}^{\text{?}} ( {X}_{i} )}{1 - {e}^{\text{?}} ( {X}_{i} )} ( {Y}_{\text{?}} - {{μ}^{\text{?}}}_{0} ( {X}_{i} ) ) .$$

$$\text{?} \text{indicates text missing or illegible when filed}$$

The total estimated incremental conversions may be computed by \hat{θ}=N₁·\hat{τ}_{ATT}. In such instances, \hat{Z}ᵢ may be the estimate of the incremental conversion for household ‘i’. To analyze the convergence of τ_{ATT} and θ, the convergence of an estimator that uses true propensity scores may be examined and then conditionally expected untreated potential outcomes:

$${Z}_{i} := \frac{{W}_{i} - e ( {X}_{i} )}{1 - e ( {X}_{i} )} ( {Y}_{i} - {μ}_{0} ( {X}_{i} ) ) .$$

Such an estimator may be easy to analyze and/or may have similar asymptotic behavior as the feasible estimator (τ_{ATT}) with estimated propensity score and outcome models. In some instances, one or more assumptions may be made such that:

$${σ}^{2} := \frac{1}{{ℙ ( W = 1 )}^{2}} \cdot 𝔼 [ {( Z - W \cdot {τ}_{ATT} )}^{2} ]$$

may be the variance of and the estimate of τ_{ATT}. Further, under certain assumptions, it may be the case that the estimate \hat{τ}_{ATT} may follow:

$$\sqrt{n} ( {\hat{τ}}_{ATT} - {τ}_{ATT} ) {\to }^{d} 𝒩 ( 0 , {σ}^{2} )$$

In some instances, the total number of incremental conversions may be θ=N₁ τ_{ATT}, which may be estimated by \hat{θ}=N₁·\hat{τ}_{ATT}. The variance of the estimate may be

$${σ}_{θ}^{2} = {N}_{1}^{2} \cdot {σ}^{2} .$$

As such, the estimate \hat{θ} may obey:

$$\sqrt{n} ( \hat{θ} - θ ) {\to }^{d} 𝒩 ( 0 , {σ}_{θ}^{2} )$$

In some instances, (1−α) confidence intervals may be constructed by letting

$${M}_{α} = \frac{{σ}_{θ}}{\sqrt{n}} \cdot {Φ}^{- 1} ( 1 - \frac{α}{2} )$$

Under certain conditions, as n→∞, the following may be held:

$$ℙ ( θ ∈ [ \hat{θ} - {\hat{M}}_{α} , \hat{θ} + {\hat{M}}_{α} ] ) \to 1 - α$$

Further, \hat{σ}² may be estimated by:

$${\hat{σ}}^{2} = \frac{1}{n - 1} \cdot {( \frac{n}{{n}_{1}} )}^{2} {\sum }_{i = 1}^{n} {( {Z}_{i} - {W}_{i} \cdot {τ}_{ATT} )}^{2}$$

Similarly,

$${σ}_{θ}^{2}$$

may be estimated by:

$${\hat{σ}}_{θ}^{2} = {N}_{1}^{2} \cdot {\hat{σ}}^{2}$$

and confidence intervals may be estimated using:

$${\hat{M}}_{α} = \frac{{\hat{σ}}_{θ}}{\sqrt{n}} \cdot {Φ}^{- 1} ( 1 - \frac{α}{2} )$$

Building Wald-type confidence intervals may yield:

$$ℙ ( θ ∈ [ \hat{θ} - {\hat{M}}_{α} , \hat{θ} + {\hat{M}}_{α} ] ) \to 1 - α$$

In some instances, the advanced audience may be defined over the whole population, but there may exist a realization of the advanced audience within the sample. So, [symbol] may be the whole audience and [symbol] = [symbol] ∩{1, . . . , n}. In some instances, [symbol] may be the number of exposed households in the audience. The expected total incremental conversions in the advanced audience may be denoted by:

$${τ}_{ATT}^{ℐ} := 𝔼 [ Y ( 1 ) - Y ( 0 ) \vert ℐ , W = 1 ] and {θ}_{ℐ} = {N}_{ℐ} \cdot {τ}_{ATT}^{ℐ}$$

In some instances, an estimate for the total incremental conversions in an advanced audience may be given by:

$${\hat{τ}}_{ATT}^{ℐ} := \frac{{\sum }_{i ∈ \hat{ℐ}} {\hat{Z}}_{i}}{{n}_{\hat{ℐ}}}$$

$$where$$

$${n}_{\hat{ℐ}} = {\sum }_{i ∈ \hat{ℐ}} {W}_{i}$$

may be the number of exposed households in the advanced audience. It further may follow that:

$${\hat{θ}}_{ℐ} = {N}_{ℐ} \cdot {\hat{τ}}_{ATT}^{ℐ}$$

An estimate of a confidence interval may be given by the following, as | [symbol] |→∞:

$$ℙ ( {θ}_{ℐ} ∈ [ {\hat{θ}}_{ℐ} - {σ}_{ℐ} \sqrt{\vert \hat{ℐ} \vert} {Φ}^{- 1} ( 1 - α / 2 ) , {\hat{θ}}_{ℐ} + {σ}_{ℐ} \sqrt{\vert \hat{ℐ} \vert} {Φ}^{- 1} ( 1 - α / 2 ) ] ) \to 1 - α$$

$$where$$

$${σ}_{ℐ}^{2} = \frac{1}{{( ℙ ( W = 1 \vert i ∈ ℐ ) )}^{2}} 𝔼 [ {( Z - W \cdot {τ}_{ATT}^{ℐ} )}^{2} \vert i ∈ ℐ ]$$

The prior equation may be estimated by

$${\hat{σ}}_{ℐ}^{2} = \frac{1}{\vert \hat{ℐ} \vert - 1} \frac{{\vert \hat{ℐ} \vert}^{2}}{{n}_{\hat{ℐ}}^{2}} {\sum }_{i ∈ \hat{ℐ}} {( {\hat{Z}}_{i} - {W}_{i} \cdot {\hat{τ}}_{ATT}^{ℐ} )}^{2}$$

In some instances, the estimates may become noisy if ê(Xᵢ) gets close to one. Stated another way, the estimates may become noisy if there are few unreached households within an advanced audience.

In some instances, the equations above may assume that cross-fitting is being implemented. Cross-fitting may be implemented using the following steps: 1) randomly split the data into two equally sized sets, split 1 and split 2. In some instances, the split may be performed using stratified sampling, stratifying on reached status, conversion, and/or advanced audience. 2) The outcome model and the propensity model may be trained using split 1. In some instances, the outcome model may be trained on the unreached households in split 1. 3) The estimator may be evaluated by using the models trained on split 1 while plugging in the data from split 2. The result thereof may be θ₍₂₎. 4) The variance σ²₍₂₎ may be estimated by plugging in data from split 2 and using the models trained on split 1. 5) The data sets may be flipped and the process up to step 5 may be repeated: train the models on split 2 and evaluate by plugging in the data from split 1. The result thereof may be θ₍₁₎ and σ²₍₁₎. 6) The final point estimate may be determined by averaging θ₍₂₎ and θ₍₁₎ and the final variance estimate may be determined by averaging σ²₍₂₎ and σ²₍₁₎.

In some instances, cross-fitting may facilitate the use of data more efficiently relative to data splitting, which may result in asymptotic normality and/or fast, unbiased convergence as the data in the estimator is independent of the data used to train the models.

In some instances, for each household ‘i’ in a sample, a weight ‘w’ may be assigned. The weights may be intended to account for any bias in the sampling and/or may be used for the sample values. It may be desirable for θ=N₁·τ_{ATT} where N may be the number of exposed households in the population.

Incremental conversion may be estimated using:

$${\hat{θ}}_{weighted} := {\sum }_{i = 1}^{n} {w}_{i} {\hat{Z}}_{i} \\ {\hat{τ}}_{ATT , weighted} := \frac{{\hat{θ}}_{weighted}}{{\sum }_{{w}_{i} = 1} {w}_{i}}$$

In some instances, [symbol] [\hat{θ}_{weighted}]=θ and the following may be calculated:

$${σ}^{2} = Var ( {τ}_{ATT} ) = \frac{1}{ℙ {( W = 1 )}^{2}} \cdot 𝔼 [ {( Z - W \cdot {τ}_{ATT} )}^{2} ]$$

As n→∞, the following may hold:

$$\sqrt{n} ( {\hat{τ}}_{ATT , weighted} - {τ}_{ATT} ) {\to }^{d} 𝒩 ( 0 , {σ}_{θ}^{2} )$$

As in the unweighted case, an estimator of σ² may be obtained by:

$${\hat{σ}}_{weighted}^{2} = {( \frac{{\sum }_{i = 1}^{n} {w}_{i}}{{\sum }_{{w}_{i} = 1} {w}_{i}} )}^{2} \frac{{\sum }_{i = 1}^{n} {{w}_{i} ( {Z}_{i} - {W}_{i} \cdot {\hat{τ}}_{ATT , weighted} )}^{2}}{{\sum }_{i = 1}^{n} {w}_{i}}$$

$$and$$

$${\hat{σ}}_{θ , weighted}^{2} = {( {\sum }_{{W}_{i} = 1} {w}_{i} )}^{2} \cdot {\hat{σ}}_{weighted}^{2}$$

From the above estimate, Wald-type (1−α)-confidence intervals for the total number of incremental conversions can be constructed so that as n→∞:

$$ℙ ( θ ∈ [ {\hat{θ}}_{weighted} - {M}_{α} , {\hat{θ}}_{weighted} + {M}_{α} ] ) \to 1 - α ,$$

$$where$$

$${M}_{α} = \frac{{\hat{σ}}_{θ , weighted}}{\sqrt{n}} {Φ}^{- 1} ( 1 - \frac{α}{2} )$$

In some instances, a problem with statistical inference may be estimating an effect of a binary treatment. Estimating the effect of an advertising campaign on an outcome variable (e.g., online conversions, location visits, in-store purchases, etc.) may be difficult. The binary treatment may be reached vs. unreached by the advertising campaign, and an interesting value may be measuring an average impact for those reached (Average Treatment effect on the Treated (ATT)), and/or an extended average impact everyone reached (Average Treatment Effect (ATE)). In some instances, the average effects may be extended to measure a heterogeneous effect of the binary treatment (Conditional Average Treatment Effect (CATE)) for reached and unreached by the advertising campaign, at an individual level.

A theme in statistics may include how to measure and/or reduce bias and variance associated with a statistical estimator. Consider an example where there is an estimand, θ, which may be some fixed but unknown number. Further, consider a random sample of n data, say Y₁, Y₂, . . . , Yₙ that can help in estimating θ. In particular, it may be desirable to understand the performance of an estimator, say \hat{θ}=f(Y₁, Y₂, . . . , Yₙ). Since the estimator may be a function of the data, and the data may have uncertainty ( ), it is important to understand how sample-to-sample variations may translate into how closely \hat{θ} may estimate θ. One common measure of performance may be Mean Squared Error (MSE) which may be the expected squared deviation of \hat{θ} from θ, or MSE(\hat{θ})=E_{Y}[(\hat{θ}−θ)²], where the expectation may be over the randomness of the data. In some instances, the MSE(\hat{θ}) may be shown to be MSE(\hat{θ})=Var(\hat{θ})+Bias(\hat{θ})². Some of the focus may be on unbiased estimators of θ as then the concern may be limited to their variance. However, there may be better estimators (in terms of MSE) that may strike a tradeoff between variance and bias.

Some of the variation in the Y's may come from confounders which may be referred to as covariates, signals, and/or factors. For example, in an advertising campaign, the outcomes could be affected by household income, location, ethnicity, prior purchase behavior, etc. Collectively, the confounders may be referred to as X, which may be considered as a vector. The confounders may be divided into three groups. First, known-knowns may be factors that may be available and/or known to affect Y in various ways. In an example, an experiment with tomato seeds grown in different locations with different sun exposures and water availability, it may be beneficial to account for location difference by blocking for location. For example, mini-experiments may be run within each location so that location effects may be calculated and removed when comparing the effects of the different tomato seeds. In some instances, blocking can improve precision by accounting for factors that may be uninteresting by themselves, but may account for variations in Y. In some instances, there may be a loss of statistical power in accounting for blocked confounders that may not affect Y. As such, not all confounders may be blocked, but rather confounders that may have a more significant effect on Y.

Second, known-unknowns may be factors that may be available but may not be known to affect Y in a significant manner. In some instances, the known-unknowns may be known X's that may not fall into the first group. In some instances, it may be possible to post-experiment use this group to improve an estimation.

Third, unknowns may be factors that may be unknown. In some instances, the unknowns may be confounders that may not be collected and/or factors that may not be considered. Failing to consider the unknowns may expose the estimator to potential biases as the treated and untreated could be unbalanced. In some instances, randomization may be used as a potential remedy for the unknowns.

In some instances, estimating the impact of a treatment vs. a control (also known as A/B testing) may be randomized experiments. First, the experimental unit may be the thing that may be provided the treatment or non-treatment. For example, the experimental unit for a clinical trial may be a person, while for an advertising campaign, outcomes may be measured at the household level such that the household may be the experimental unit. Keys to a randomized experiment may be blocking and randomization. Blocking may help control for obvious confounders and randomization may help with potential impacts from the known-unknown and/or unknown confounders by statistically allocating them equally across the treatment and control groups. As such, the bias that may be induced by ignoring the confounders may be taken into increased variance by randomizing their impact equally between the two groups. In some instances, a comparison across the two groups may be straightforward as \hat{θ}=Y̅_{T}−Y̅_{C} which may be unbiased for θ by the randomization and/or may further lead to valid non-parametric hypothesis testing via permutation tests. In a blocked experiment, the randomization may be done within each block.

In practice, a clean randomized experiment may be difficult to achieve. Further, even with randomization, there may be potential confounders that may be randomly unbalanced across the treatments. As such, post-experiment adjustments may be implemented by applying weights and/or building outcome models.

Consider a set of n observational data (Wᵢ, Xᵢ, Yᵢ) where i=1, 2, . . . , n. Wᵢ may be an indicator variable that may indicate whether or not the ith observation may have been treated (W=1) or not treated (W=0), Yᵢ may be the outcome variable for the ith observation, and Xᵢ may be a vector of covariates associated with the ith observation. In some instances, there may be interest in obtaining the ATT, T, which may be the average change in Y from the treatment where the average may be over the observations with W=1. A naïve solution may be to take the average of the treated and subtract the average of the untreated:

$$\hat{τ} = [ \frac{1}{{N}_{1}} * {\sum }_{i} ( {Y}_{i} * {W}_{i} ) ] - [ \frac{1}{{N}_{0}} * {\sum }_{i} ( {Y}_{i} * ( 1 - {W}_{i} ) ) ]$$

where N₁=ΣᵢWᵢ and N₀=Σᵢ(1−Wᵢ) may be the number of observations treated and untreated, respectively. If the data was from a randomized experiment, the approach may be acceptable as the randomization may ensure that the impacts that X's have on the Y's may be statistically equal across the two groups. In some instances, \hat{τ} may be unbiased in the example. However, for observational data, it may be expected to have X imbalances between the two groups and if some of the covariates may affect the outcome, then the imbalances may pass through to \hat{τ} as bias. In some instances, untreated observations may be selectively chosen that may match the treated observation, but may be challenging.

First, the covariates that affect Y may need to be balanced, but deciding which to select may be difficult. Second, closeness (a distance metric in the X-space) may need to be defined. Third, determining a likelihood of finding exact matches may be difficult. Another approach using outcome modeling may be a better approach.

The estimand may be the expected change in the outcome from the treatment for those treated:

$${τ}_{ATT} = E [ Y ( 1 ) - Y ( 0 ) \vert W = 1 ]$$

where Y(1) may be the outcome if treated and Y(0) may be the outcome if not treated. For the treated, Y(1) may be observed so an estimate of the counterfactual, Y(0), may be determined using the untreated data. In some instances, the solution may be to build a regression model using the untreated data.

In some instances, it may be desired to estimate:

$${μ}_{0} ( x ) = E [ Y \vert X = x , W = 0 ]$$

using the (Xᵢ, Yᵢ) where W=0. After fitting the model, the model may be applied to the treated data to estimate Y(0). The outcome adjusted estimator may be:

$${\hat{τ}}_{ATT}^{( OC )} = 1 / {N}_{1} {\sum }_{\{ i : {W}_{i} = 1 \}} ( {Y}_{i} - {\hat{μ}}_{0} ( {X}_{i} ) )$$

If \hat{μ}₀ is unbiased, then \hat{τ}_{ATT} may be unbiased for τ_{ATT} and since the regression model may account for variations in the outcome from the covariates, the estimator may be efficient. In instances in which there may be imbalances in the X's between the treatment and control, the extrapolating behavior of \hat{μ}₀ when estimating the counterfactual for those treated that are much different may be relied on, in terms of X, from the untreated. Further, if the μ₀ model (e.g., the underlying statistical model may not be flexible to properly fit the μ₀ surface) is misspecified, or if there may be unaccounted confounding variables, there may be remaining bias.

Another approach to estimate τ_{ATT} may be through use of the propensity to be treated function, which may be defined as:

$$e ( X ) = P ( W = 1 \vert X )$$

The idea may be that knowing e(X), then for those observations with the same e(·), the actual assignment into treated or untreated (whether W=1 or W=0) may be random. As such, the propensity to reconstruct a pseudo-randomized study by matching on the propensity may be used. Exact matching may be impractical, but non-overlapping propensity bins may be created and average outcomes within each of the propensity bins may be compared and aggregated for a final estimate of τ_{ATT}.

The propensity function may be modeled as W=e(X) and since W is binary, the model may be fit via a two-class classification algorithm using n observations. Some considerations may include, first, using e(·) to match groups of treated observations with groups of untreated observations. Overlap of the propensity model between the treated and untreated may be implemented. For high-propensity bins, there may be more treated than untreated observations and vice-versa for the low-propensity bins. In some instances, plotting and comparing the histograms of the estimated propensity scores for the two groups may be performed to ensure sufficient overlap.

Second, the covariates used may be known chronologically before the treatment may be applied, such as the first exposure to an advertisement. For example, using “watched program Z” as a covariate when everyone who watched the program may see an advertisement and thus be treated, may not prove to be fruitful.

Third, there may be covariates that may be of importance to fitting the propensity, but may not affect the outcome. Using covariates that may not affect the outcome may not help with reducing bias for estimating τ_{ATT}. As such, those covariates may not be used. In some instances, an outcome model may be built to select important variables and the fitting of the propensity model may be restricted to the selected covariates.

Fourth, after fitting the propensity model, for each covariate, the distribution may be similar within a propensity bin for the treated and untreated. In some instances, such may be a validation that the propensity modeling approach may be working.

Fifth, the predictions from the model may be used for matching, and may include using k-fold and/or cross-fitting to avoid over-fitting. Such may ensure that an observation may not be used in making its own predictions. After fitting e(·), the estimate propensity function may be ê(·), which may be used in place of e(·) for matching.

Outcome modeling may reduce the variance of the estimator by accounting for confounding covariates, and propensity modeling may reduce bias by matching observations by pseudo-random experiment. In some instances, combining the two methods may include beneficial properties:

$${\hat{τ}}_{ATT}^{( DR )} = \frac{1}{{N}_{1}} * {\sum }_{\{ i : {W}_{i} = 1 \}} ( {Y}_{i} - {\hat{μ}}_{0} ( {X}_{i} ) ) - \frac{1}{{N}_{1}} * {\sum }_{\{ i : {W}_{i} = 0 \}} ( \frac{\hat{e} ( {X}_{i} )}{1 - \hat{e} ( {X}_{1} )} ) ( {Y}_{i} - {\hat{μ}}_{0} ( {X}_{i} ) )$$

The first term may be

$${\hat{τ}}_{ATT}^{( OC )}$$

and the second term may be a weighted sum of the outcome model errors on the untreated observations, where the weights may be related to their propensity. If the outcome model is unbiased, then the first term may be unbiased and the expected value of the second term may be zero, as the model errors may have zero expected value. If the outcome model is unbiased, then

$${\hat{τ}}_{ATT}^{( DR )}$$

may be unbiased. Alternatively, or additionally, if the outcome model is biased, then the model errors may have a remaining structure. For this estimator, if the propensity model is unbiased, then the second term may correct for the bias. The expected value of (Yᵢ−\hat{μ}₀(Xᵢ)) may be the model bias at Xᵢ and the weights in the second term may change the emphasis from the untreated X-distribution to the treated X-distribution. As such, the second term may remove the bias from the first term. In other words, the second term may take the bias measured on the untreated and may use the propensity model to weight it so that the treated bias may be measured. In instances in which the propensity model is unbiased, a biased outcome model may be used and may still have an unbiased estimator. Such property may be referred to as double robustness. Under some conditions (e.g., that confounders may be known and/or sufficient propensity overlap),

$${\hat{τ}}_{ATT}^{( DR )}$$

may be asymptotically efficient, which may mean that as n gets large, the variance of

$${\hat{τ}}_{ATT}^{( DR )}$$

may hit its lower bound.

In some instances, it may be desirable to extend the models to estimate the individual, heterogeneous effects of the treatment. In such instances, the new estimand may be a function (not a parameter):

$$τ ( x ) = E [ Y ( 1 ) - Y ( 0 ) \vert X = x ]$$

If μ₁(x) is the expected outcome for the treated with covariates X=x and μ₀(x) is the expected outcome for the untreated with the same covariate values, then τ(x)=μ₁(x)−μ₀(x), which may be the effect of the treatment for observations with X=x. The function may be applied to both the observed treated and untreated, as well as future observations.

In some instances, meta-learners may be model agnostic approaches for modeling τ(x). The idea may be to fit a few models, using any modeling approach that may be appropriate, and then combine the models (depending on the learner) to estimate τ(x). In some instances, the models may be fit with MSE loss, using train and test for hyper-parameter modeling, with final predictions made using cross-fitting to ensure independent predictions may be made for each observation.

An S-learner may be an approach, where a single model may be fit, and where the W may be included along with the covariates, represented by \hat{μ}^{(S)}(x, w). In such instances, the estimator may be:

$${\hat{τ}}^{( s )} ( x ) = {\hat{μ}}^{( s )} ( x , w = 1 ) - {\hat{μ}}^{( s )} ( x , w = 0 )$$

The S-learner may have problems with tree-based models that may omit W as a variable and/or with regularization as it can bias W's contribution, which may bias \hat{μ}^{(s)}(x, w). Alternatively, or additionally, the S-learner may work when τ(x) is a simple function of x with many covariates having zero contribution.

Another approach may be T-learner, which may fit two outcome models—one for the treated and one for the untreated, which may be referred to as μ₁(x) and μ₀(x), respectively. The two outcome models may be fit using any modeling approach and/or the two outcome models may be fit using different statistical methods. After fitting, the T-learner estimator may be:

$${\hat{τ}}^{( s )} ( x ) = {\hat{μ}}_{1} ( x ) - {\hat{μ}}_{0} ( x )$$

The T-learner approach may suffer from a good estimate of μ₁ and μ₀ and/or a poor estimate of the difference there between. The loss functions may not coincide with the desired estimate of τ(·). Alternatively, or additionally, when the group sizes may be unbalanced, the smaller group \hat{μ} may have a high variance and using regularization to counter the high variance may bias it. As such, the T-learner approach may work well with relatively balanced group sizes, but may not work as well when the group sizes may be imbalanced.

Some two-stage meta-learners may attempt to correct the deficiencies identified with the S-learner and the T-learner approaches. The first step may be the same as the T-learner approach, fitting outcome models \hat{μ}₁ and \hat{μ}₀. The outcome models may be used to create imputed treatment effects for each observation, and then the imputed treatment effects may be modeled. The learners may share information across the groups of data which may make the learners more robust.

The X-learner may begin with fitting μ₁(x) and μ₀(x) using the treated and untreated groups, respectively. The imputed treatment effects may be estimated separately for each group using the counterfactual from the other group. For the treated group

$$( W = 1 ) , {D}_{i}^{1} = {Y}_{i} - {\hat{μ}}_{0} ( {X}_{i} ) ,$$

while for the untreated group

$$( W = 0 ) , {D}_{i}^{0} = {\hat{μ}}_{1} ( {X}_{i} ) - {Y}_{i} .$$

The next step may be to separately fit the D¹ and D⁰ imputed treatment effects using the covariates X. Such may yield two predictors, \hat{τ}₁(x) from the treated group and \hat{τ}₀(x) from the untreated group. Finally, to make a prediction for any x, a weighted average of the two predictors may be used, which may include using the propensity score at x to form the weighting. As such, the final predictor may be:

$${\hat{τ}}^{( X )} ( x ) = \hat{e} ( x ) {\hat{τ}}_{0} ( x ) + ( 1 - \hat{e} ( x ) ) {\hat{τ}}_{1} ( x )$$

In some instances, the imputed treatment effects for the treated may use a counterfactual from the untreated observations and vice-versa for the untreated imputed treatment effects. As such, if the propensity score is relatively high/low at x, then the untreated/treated counterfactuals may be trusted and as a result, \hat{τ}₀/\hat{τ}₁ may be trusted, which may be why the propensity based weights may be used.

A variation of the X-learner may be the DR-learner, where the first steps may be the same but the imputed treatment effects may be estimated for the treated as:

$${D}_{i}^{1} = ( {\hat{μ}}_{1} ( {X}_{i} ) - {\hat{μ}}_{0} ( {X}_{i} ) ) + \frac{{Y}_{i} - {\hat{μ}}_{1} ( {X}_{i} )}{\hat{e} ( {X}_{i} )}$$

while for the untreated as:

$${D}_{i}^{0} = ( {\hat{μ}}_{1} ( {X}_{i} ) - {\hat{μ}}_{0} ( {X}_{i} ) ) - \frac{{Y}_{i} - {\hat{μ}}_{0} ( {X}_{i} )}{1 - \hat{e} ( {X}_{i} )}$$

In some instances, the first terms may be the T-learner values and the second terms may adjust for any modeling misspecification. In some instances, the DR-learner may finish by joining the D¹ and D⁰ data and fitting a combined model for a final estimate of τ(x). In some instances, the propensity scores may be in the denominator of the imputed treatment effects. As such, if any of the ê's may be close to zero or one, then the D's may be unstable. The DR-learner may be sensitive to violations of the propensity overlap assumption.

An R-learner may take a similar two-stage approach as the X-learner and/or the DR-learner. The R-learner may first consider the conditional-mean outcome which may average out the treatment effect:

$$μ ( x ) = E [ Y \vert X = x ] = {μ}_{0} ( x ) + e ( x ) τ ( x )$$

and if μ(x) and e(x) are known, then

$${Y}_{i} - μ ( {X}_{i} ) = ( {W}_{i} - e ( {X}_{i} ) ) * τ ( {X}_{i} ) + {ϵ}_{i}$$

may provide an approach to estimate τ(·). In the equation, E[ϵᵢ]=0 for all i. To provide some insight, consider values of X=x where e(x)=0.5, so for such x's, there may be an equal chance of treatment assignment. Without knowing the treatment assignment, the expected value for their outcomes may be μ(x). Alternatively, or additionally, for the observations that may be assigned to the treatment group (Wᵢ=1), it may be expected that their Yi to contain a half bump of τ(x), while those assigned to the untreated group (Wᵢ=0) may have a half drop of τ(x). As such, the deviations in the outcomes from their conditional-mean may contain information about τ(·), including when their assignments may be unlikely given their propensity.

In some instances, μ(x) and/or e(x) may not be known, but may be estimated using statistical methods. For example, let \hat{μ}(x) be the estimated conditional-mean function and ê(x) be the estimated propensity score function. These two may be inserted into the above equation and then solving for τ(·) using MSE as the loss function. The R-learner estimate of τ(·) may be the solution to the loss function:

$$\frac{1}{n} {\sum }_{i = 1}^{n} {[ ( {Y}_{i} - \hat{μ} ( {X}_{i} ) ) - ( {W}_{i} - \hat{e} ( {X}_{i} ) ) * τ ( {X}_{i} ) ]}^{2} + Λ ( τ ( \cdot ) )$$

where Λ(τ(·)) may be a regularizer on the complexity of τ(·). The first term (Yᵢ−\hat{μ}(Xᵢ)) may be the errors of the mean-outcome estimate while the second term (Wᵢ−ê(Xᵢ)) may be the errors of the propensity score estimate, so that the loss function may control for potential exogenous factors (e.g., non-measured confounders).

Estimation of τ(x) may be performed in a similar manner as with the X-learner and/or the DR-learner, by calculated imputed treatment effects. For those treated observations (W=1):

$${D}_{i}^{1} = \frac{{Y}_{i} - \hat{μ} ( {X}_{i} )}{1 - \hat{e} ( {X}_{i} )}$$

and for untreated observations (W=0):

$${D}_{i}^{0} = \frac{\hat{μ} ( {X}_{i} ) - {Y}_{i}}{\hat{e} ( {X}_{i} )}$$

In some instances, \hat{τ}^{(R)}(x) may be the fit to a weighted regression of the joined D¹ and D⁰ and using weights proportional to (1−ê(Xᵢ))² for W=1 and (ê(Xᵢ))² for W=0. In some instances, such an estimator may have quasi-oracle properties under certain conditions, or stated another way, the asymptotic behavior of such an estimator may not be affected by plugging in the estimates of μ₀(x) and e(x) over the oracle estimate where the functions may be assumed known. In some instances, the imputed treatment effects could be unbounded as ê(·) may tend toward one for the treated or to zero for the untreated. Alternatively, or additionally, the weights may tend toward zero in such cases. As such, while there may be checks that the ê(X)'s may be bounded away from zero and/or one, the numeric instability issues may not be as pronounced as for the DR-learner.

Modifications, additions, or omissions may be made to the system 100 without departing from the scope of the present disclosure. For example, any of the components of FIG. 1 may be divided into additional or combined into fewer components.

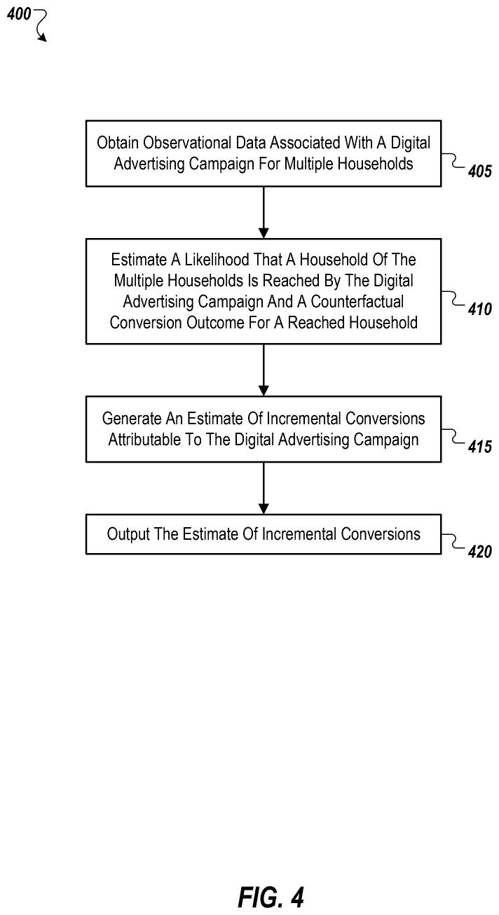

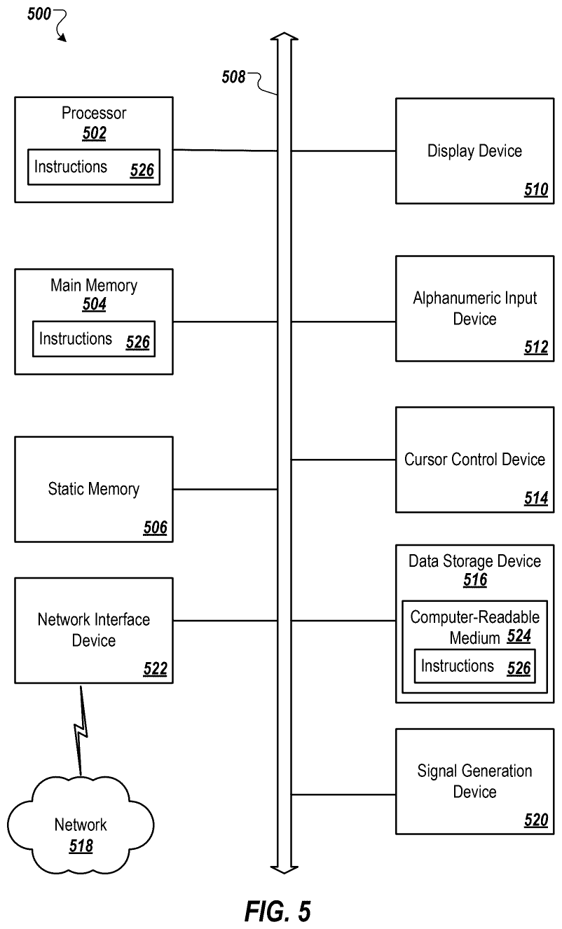

FIG. 4 illustrates a flowchart of an example method 400 of digital incremental conversion, in accordance with at least one embodiment of the present disclosure. The method 400 may be performed by processing logic that may include hardware (circuitry, dedicated logic, etc.), software (such as is run on a general purpose computer system or a dedicated machine), or a combination of both, which processing logic may be included in any computer system or device such as the computing device 110 of FIG. 1 or the computing device 500 of FIG. 5.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 405, processing logic may obtain observational data associated with a digital advertising campaign for multiple households. The observational data may include a reach indicator, one or more covariates, and/or an observed conversion outcome. The observational data may be obtained from one or more digital platforms. In some instances, the reach indicator may indicate whether a household was reached at least once by the digital advertising campaign. In some instances, the one or more covariates may include household-level digital activity data measured independent of a first campaign exposure. In some instances, the observed conversion outcome may include at least one of a conversion count during a measurement window, purchased units during the measurement window, revenue during the measurement window, an online conversion, a location visit, and/or an in-store purchase.

At block 410, the processing logic may estimate a likelihood that a household of the multiple households may be reached by the digital advertising campaign and a counterfactual conversion outcome for a reached household. In some instances, the estimating may be performed as a function of the one or more covariates. Alternatively, or additionally, the counterfactual conversion outcome may be estimated using data from unreached households of the multiple households. In some instances, the counterfactual conversion outcome may represent an expected conversion outcome for the reached household if the reached household had not been reached by the digital advertising campaign.

At block 415, the processing logic may generate an estimate of incremental conversions attributable to the digital advertising campaign. The estimate of incremental conversions may be obtained by combining differences between the observed conversion outcome of the reached households and the counterfactual conversion outcome for the reached households with a propensity-based correction derived from outcomes of the multiple households based on the estimated likelihood that a household may be reached.

In some instances, estimating the likelihood that the household is reached may include training a propensity model using the observational data to predict reach status from the one or more covariates. In some instances, estimating the counterfactual conversion outcome may include training an outcome model using data from the unreached households to predict expected conversion outcomes as a function of the one or more covariates. Alternatively, or additionally, the outcome model may be applied to reached households to produce the counterfactual conversion outcome, for each of the reached households, which may represent the expected conversion outcome if not reached.

In some instances, the propensity-based correction may be derived from differences between the observed conversion outcome of the unreached households and predicted conversion outcomes for the unreached households. In some instances, deriving the propensity-based correction may include weighting contributions of the unreached households based on the estimated likelihood of being reached so that the unreached households may be reweighted to reflect a covariate distribution of the reached households.

In some instances, generating the estimate of incremental conversions may include computing household-level incremental conversion contributions for the multiple households and aggregating the household-level incremental conversion contributions. Alternatively, or additionally, incremental conversions may be estimated for a subset of households by aggregating the household-level incremental conversion contributions over the subset of households. Alternatively, or additionally, an uncertainty measure may be computed for the estimate of incremental conversions based on variability of the household-level incremental conversion contributions.

At block 420, the processing logic may output the estimate of incremental conversions.

Modifications, additions, or omissions may be made to the method 400 without departing from the scope of the present disclosure. For example, the processing logic may incorporate predetermined weights associated with the multiple households. In some instances, generating the estimate of incremental conversions may include weighting household-level incremental conversion contributions based on the predetermined weights

In another example, the designations of different elements in the manner described is meant to help explain concepts described herein and is not limiting. Further, the method 400 may include any number of other elements or may be implemented within other systems or contexts than those described.

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining observational data associated with a digital advertising campaign for a plurality of households, the observational data comprising a reach indicator, one or more covariates, and an observed conversion outcome;
estimating a likelihood that a household of the plurality of households is reached by the digital advertising campaign and a counterfactual conversion outcome for a reached household, wherein:
the estimating is performed as a function of the one or more covariates; and
the counterfactual conversion outcome is estimated using data from unreached households of the plurality of households;
generating an estimate of incremental conversions attributable to the digital advertising campaign by combining:
differences between the observed conversion outcome of the reached households and the counterfactual conversion outcome for the reached households; and
a propensity-based correction derived from outcomes of the plurality of households based on the estimated likelihood that a household is reached; and
outputting the estimate of incremental conversions.

2. The method of claim 1, wherein the counterfactual conversion outcome represents an expected conversion outcome for the reached household if the reached household had not been reached by the digital advertising campaign.

3. The method of claim 1, wherein the reach indicator indicates whether a household was reached at least once by the digital advertising campaign and wherein the one or more covariates comprise household-level digital activity data measured independent of a first campaign exposure.

4. The method of claim 1, wherein the observational data is obtained from one or more digital platforms.

5. The method of claim 1, wherein the observed conversion outcome comprises at least one of a conversion count during a measurement window, purchased units during the measurement window, revenue during the measurement window, an online conversion, a location visit, and an in-store purchase.

6. The method of claim 1, wherein estimating the likelihood that the household is reached comprises training a propensity model using the observational data to predict reach status from the one or more covariates.

7. The method of claim 1, wherein estimating the counterfactual conversion outcome comprises training an outcome model using data from the unreached households to predict expected conversion outcomes as a function of the one or more covariates.

8. The method of claim 7, further comprising applying the outcome model to reached households to produce the counterfactual conversion outcome, for each of the reached households, representing the expected conversion outcome if not reached.

9. The method of claim 1, wherein the propensity-based correction is derived from differences between the observed conversion outcome of the unreached households and predicted conversion outcomes for the unreached households.

10. The method of claim 9, wherein deriving the propensity-based correction comprises weighting contributions of the unreached households based on the estimated likelihood of being reached so that the unreached households are reweighted to reflect a covariate distribution of the reached households.

11. The method of claim 1, wherein generating the estimate of incremental conversions comprises computing household-level incremental conversion contributions for the plurality of households and aggregating the household-level incremental conversion contributions.

12. The method of claim 11, further comprising estimating incremental conversions for a subset of households by aggregating the household-level incremental conversion contributions over the subset of households.

13. The method of claim 11, further comprising computing an uncertainty measure for the estimate of incremental conversions based on variability of the household-level incremental conversion contributions.

14. The method of claim 1, further comprising incorporating predetermined weights associated with the plurality of households, wherein generating the estimate of incremental conversions comprises weighting household-level incremental conversion contributions based on the predetermined weights.

15. A system, comprising:
one or more non-transitory computer-readable storage media configured to store instructions; and
one or more processors communicatively coupled to the one or more non-transitory computer-readable storage media and configured to, in response to execution of the instructions, cause the system to perform operations, the operations comprising:
obtain observational data associated with a digital advertising campaign for a plurality of households, the observational data comprising a reach indicator, one or more covariates, and an observed conversion outcome;
estimate a likelihood that a household of the plurality of households is reached by the digital advertising campaign and a counterfactual conversion outcome for a reached household, wherein:
the estimate is performed as a function of the one or more covariates; and
the counterfactual conversion outcome is estimated using data from unreached households of the plurality of households;
generate an estimate of incremental conversions attributable to the digital advertising campaign by combining:
differences between the observed conversion outcome of the reached households and the counterfactual conversion outcome for the reached households; and
a propensity-based correction derived from outcomes of the plurality of households based on the estimated likelihood that a household is reached; and
output the estimate of incremental conversions.

16. The system of claim 15, wherein the counterfactual conversion outcome represents an expected conversion outcome for the reached household if the reached household had not been reached by the digital advertising campaign.

17. The system of claim 15, wherein the reach indicator indicates whether a household was reached at least once by the digital advertising campaign and wherein the one or more covariates comprise household-level digital activity data measured independent of a first campaign exposure.

18. The system of claim 15, wherein the observed conversion outcome comprises at least one of a conversion count during a measurement window, purchased units during the measurement window, revenue during the measurement window, an online conversion, a location visit, and an in-store purchase.

19. The system of claim 15, wherein estimating the likelihood that the household is reached comprises training a propensity model using the observational data to predict reach status from the one or more covariates.

20. The system of claim 15, wherein estimating the counterfactual conversion outcome comprises training an outcome model using data from the unreached households to predict expected conversion outcomes as a function of the one or more covariates.
